(19) United States
(12) Patent Application Publication
(10) Pub. No.: US 2024/0037422 A1
(43) Pub. Date: Feb. 1, 2024

(54) METHOD FOR CONSTRUCTING A USER INTERFACE KNOWLEDGE BASE, AND CORRESPONDING COMPUTER PROGRAM PRODUCT, STORAGE MEDIUM AND COMPUTING MACHINE

(71) Applicant: Orange, Issy-Les-Moulineaux (FR)

(72) Inventors: Sonia LAURENT, Chatillon Cedex (FR); Cédric FLOURY, Chatillon Cedex (FR)

(21) Appl. No.: 18/256,602

(22) PCT Filed: Nov. 24, 2021
(86) PCT No.: PCT/FR2021/052082

§ 371 Date: Jun. 8, 2023

(30) Foreign Application Priority Data
Dec. 8, 2020 (FR) FR2012822

(51) Int. Cl. G06N 5/022

(52) U.S. Cl. CPC G06N 5/022

(57) ABSTRACT

A method, implemented by a computing machine, for constructing a knowledge base. The method includes, while using a terminal, at least one update to the knowledge base based on information extracted from useful application areas of a digital image of a screenshot of at least part of the rendering from a screen of the terminal.

### CROSS-REFERENCE TO RELATED APPLICATIONS

This application is filed under 35 U.S.C. § 371 as the U.S. National Phase of Application No. PCT/FR2021/052082 entitled “METHOD FOR CONSTRUCTING A USER INTERFACE KNOWLEDGE BASE, AND CORRESPONDING COMPUTER PROGRAM PRODUCT, STORAGE MEDIUM AND COMPUTING MACHINE” and filed Nov. 24, 2021, and which claims priority to FR 2012822 filed Dec. 8, 2020, each of which is incorporated by reference in its entirety.

### BACKGROUND

### Technical Field

The field of the development is that of helping users of terminals.

More specifically, the development relates to a solution for constructing a knowledge base of a user having at least one terminal with a screen.

Once constructed (in the sense that it contains collected data), the knowledge base can, for example, be used by an intelligent assistant configured to offer contextual help to the user depending in particular on the content of the knowledge base, and therefore depending on how the user uses their (at least one) terminal.

“Terminal” refers in particular but not exclusively to a personal computer (desktop or laptop), a digital tablet, a personal digital assistant, a smartphone, a workstation, etc., or any other device that a user may use to receive, send or search for text and/or image and/or sound and/or video content.

“Content” refers in particular but not exclusively to an e-mail, a message (instant or not), a document, a search (performed with a web browser, for example), a news feed of a social network, content posted on a social network, etc.

The development can be applied in many fields, for example in the field of companies wishing to offer innovative services to their employees or customers and to help them on a daily basis in several areas (productivity, well-being and ecology) via professional or personal assistants (in B2B (business to business) or B2C (business to consumer)).

The development can also be applied in other fields: education (for pupils and students), personal development (for any user), etc.

### Related Art

Many intelligent assistants aim to help users on their terminal (PC, smartphone, tablet, etc.) by offering proactive contextual help after analysing the various activities already carried out by the user on the applications installed on the terminal. The data collected, and stored in the knowledge base, is used for example by the intelligent agent to detect repetitions in the activities that could then be notified to the user to help them in their activity or offer them a task automation.

This is particularly true now in the world of the digital company wishing to offer intelligent assistants that keep continuous track of the employee's progress and must help them to improve their productivity, their well-being or ecological aspects by saving energy or digital and therefore physical resources. For example, the intelligent assistant in the Gmail application notably offers the automatic completion and drafting of replies to electronic messages (e-mails).

Today's intelligent assistants are integrated into applications. As a result, each intelligent assistant integrates, or cooperates with, its own data collection mechanism to create its own knowledge base.

A disadvantage is that each knowledge base is linked to an application running on the terminal, and it is therefore necessary to have as many knowledge bases as there are applications.

Another disadvantage is that data collection mechanisms need to be updated frequently as applications evolve rapidly. For example, if an application integrating its own chat system (internal instant messaging) is updated, then the module (collection mechanism) that interfaces with this application to obtain the information exchanged via the chat system (that is the exchanges between the user and other people via the internal instant messaging of this application) also needs to be updated.

Another disadvantage is that the data collection mechanism is different for each application and must interface with the specific APIs (Application Programming Interfaces) of this application (assuming that it provides APIs, which is not always the case). The multiplication of applications running on terminals makes this task increasingly difficult.

The present application aims to propose improvements to at least some of the disadvantages of the state of the art.

### SUMMARY

According to a first aspect, the present application relates to a method, implemented by a computing machine, for constructing a knowledge base.

In some embodiments of the present application, said method comprises, while using a terminal, or after that use, at least one update to the knowledge base based on information extracted from useful application areas of a digital image of a screenshot of at least part of the rendering from a screen of said terminal.

In some embodiments of the present application, a method implemented by a computing machine (30) for constructing a knowledge base (DB) is proposed, characterised in that it comprises at least one update (S6) to use information contained in the knowledge base (DB) based on information extracted from useful application areas of a digital image of a screenshot of at least part of the rendering from at least one screen of a terminal, the useful application areas being areas containing at least one item of data provided to or received by at least one application via said at least one screen.

Thus, the proposed solution is based on a new approach consisting in constructing a knowledge base of a user by using screenshot and image analysis technologies, on a rendering from at least one screen of at least one terminal they use (or just used).

An advantage of the proposed solution is that it is simple to implement, at least according to some embodiments, since all that is required, in addition to the (at least one) terminal already available to the user, is a computing machine (possibly the one already present in the terminal).

Another advantage of the proposed solution, in at least some embodiments of the present application, is that it can allow a generic construction of the knowledge base, for example by avoiding access to the APIs of each application executed by the terminal. In other words, since it is not based on the APIs of the application(s) executed by the terminal, the proposed solution can allow, at least according to some embodiments, the creation of a knowledge base independent (“agnostic”) of this/these application(s), with regard to the way of collecting information related to the use of this/these application(s). The proposed solution may thus involve fewer implementation constraints in at least some embodiments of the present application.

Another advantage of the proposed solution, in at least some embodiments of the present application, is that an intelligent assistant configured to use the content of this knowledge base may also have this characteristic of independence from the application(s) used on the terminal. In other words, the intelligent assistant does not have to be application specific and can cooperate with the generic knowledge base, which can contain information related to several applications (although in a particular implementation it can also contain information related to a single application).

Yet another advantage of the proposed solution, at least according to some embodiments, is that even if the application(s) evolve(s), or if the user adds an application on their terminal, the proposed solution can continue to function without requiring an update, since it relies solely on (partial or total) screen extractions.

In some embodiments of the present application, according to a first implementation, the screenshot applies to the entire rendering from the screen.

In this first implementation, the method manages the entire screen, without trying to know the number of application windows displayed on the screen. An application window is a window linked to an execution of an application by the terminal. The first implementation applies in particular in the case where the terminal can only display one application window at a time (in the case of some smartphone terminals for example). In the case where the terminal allows multiwindowing (that is it can display several application windows simultaneously), the first implementation can also be applied but the method does not manage each application window separately (for example when the operating system of the terminal does not allow certain events linked to multiwindowing to be recovered: opening of an application window, retrieval of the position and size of an application window, etc.)

In some embodiments of the present application, according to a second implementation, the screenshot applies to part of the rendering from the screen corresponding to at least one application window displayed on the at least one screen.

In this second implementation, the method can manage separately several application windows displayed on the screen (for example, each application window displayed on the screen). This can therefore allow, at least according to some embodiments, to improve the completeness of the information collected in the knowledge base, by obtaining separately the information specific to several application windows (for example each application window).

In some embodiments of the present application, according to the second implementation, upon detection of an opening of the application window on the screen, the method comprises storing in the knowledge base information on the position, the size and/or a display rank of the application window, and, for a new update to the knowledge base, the screenshot depends on the information on the position, the size and/or the display rank.

This can be used to create a screenshot of each application window easily for example, for each new update to the knowledge base. This refers to the case where, from its opening to its closing, several successive screenshots of the same application window are created.

In some embodiments of the present application, according to the second implementation, if the terminal allows several application windows to be displayed on the screen simultaneously, the update to the knowledge base is performed in a separate knowledge base entry for each of the application windows.

In this way, in some embodiments of the present application, the knowledge base can be even more complete since it has several entries each dedicated to one of the application windows. Such embodiments of the present application may thus help intelligent assistants having access to the knowledge base to perform finer processing operations and/or achieve better results, such as providing the user with more targeted contextual help.

In some embodiments of the present application, according to the second implementation, if the terminal allows several application windows (F1 to F4) to be displayed on the screen simultaneously, at least one update (S6) to the knowledge base is performed in a separate entry of the knowledge base for each of the application windows.

In some embodiments of the present application, for a useful application area of an application window, at least one update (S6) to the knowledge base is performed conditionally taking into account an overlap rate of said useful application area by one or more other application windows.

For example, in some embodiments of the present application, for a useful application area of an application window, each update (S6) to the knowledge base is performed conditionally taking into account an overlap rate of said useful application area by one or more other application windows.

In some embodiments of the present application, the overlap rate of said useful application area by one or more other application windows depends on:
information on the position and/or the size of said useful application area;
information on a display rank of the application window; and/or
information on the position, the size and/or a display rank of the other application window(s).

In some embodiments of the present application, at least one update (S6) to the knowledge base, for the useful application area of the application window, is performed only when the overlap rate is lower than a first overlap value.

In some embodiments of the present application, according to the second implementation, for a useful application area of an application window, the method comprises a calculation of an overlap rate of said useful application area by one or more other application windows, based on:
information on the position and/or the size of said useful application area;
information on a display rank of the application window; and/or
information on the position, the size and/or a display rank of the other application window(s),
and an update to the knowledge base, for the useful application area of the application window, is performed only when the overlap rate is lower than a first overlap value.

Thus, in the case where a useful application area is overlapped with an overlap rate greater than or equal to the first overlap value, an update to the knowledge base with incomplete and/or unintelligible information can for example be avoided.

In some embodiments of the present application, according to the second implementation, upon detection of a resizing and/or a moving of an application window, the method comprises storing in the knowledge base information on the position, the size and/or the display rank of the application window, and, for at least one new update to the knowledge base, the screenshot depends on the new information on the position, the size and/or the display rank.

In this way, at least according to some embodiments, an appropriate screenshot of the application window can be created, regardless of how it is modified on the screen, by resizing and/or moving from its opening to its closing.

In some embodiments of the present application, useful application areas are areas that are not related to a presentation of features of at least one application executed by the terminal and for which an application window is displayed on the screen.

In other words, the method can, for example, ignore the areas of an application window that are reserved for the presentation of features (menus, buttons and/or other mechanisms) of an application. The remaining (that is non-ignored) areas constitute the useful application areas. They contain incoming useful data, provided by the user to the application, and outgoing useful data, provided by the application to the user. Thus, it is possible for example to avoid adding information to the knowledge base that is not related to the way the user of an application uses their terminal, but that is data related solely to the presentation of features of the application (and therefore does not reflect the way the user uses their terminal).

In some embodiments of the present application, extracting information from the useful application areas comprises an extraction belonging to the group comprising: extracting information on text appearing in the useful application areas by means of an optical character recognition technique; and extracting information on image elements appearing in the useful application areas by means of a computer vision technique.

In this way, the knowledge base can be enriched with two types of information: the one extracted on text and/or the one extracted on image elements. Thus, most, or in some cases all, of the useful data (incoming or outgoing) exchanged between the user and the application(s) running on the terminal is covered.

In some embodiments of the present application, the extraction (S4) of information from the useful application areas takes into account a detection confidence score.

In some embodiments of the present application, extracting information from the useful application areas comprises considering an extracted item of information when it is associated with a detection confidence score greater than a first confidence value.

In this way, such a consideration can for example help to improve, at least in some embodiments, the quality of the information collected in the knowledge base.

In some embodiments of the present application, extracting information from the useful application areas comprises, after detecting that a useful application area contains a video, subsequently updating the knowledge base based on information extracted from the video.

This can help to avoid using too many system resources (notably computing resources) during a real-time execution of the method, while allowing a simply delayed enrichment (for example in the evening or at night, when the terminal is less used) of the knowledge base with information extracted from a video. In a variant, which is degraded but less costly because it does not perform the subsequent update, the method can ignore a useful application area if it detects that it contains a video.

In some embodiments of the present application, a new update to the knowledge base is performed on a triggering event belonging to the group comprising a periodic event and an event indicating an end of data entry via one or more items of entry equipment of a user interface.

Increasing the number of updates can help in some embodiments of the present application to increase the completeness of the knowledge base. The periodicity of the periodic event can be chosen, in some embodiments, to attempt to best record useful data exchanges between the user and the application(s), while attempting to make the best use of the resources of the computing machine. In a variant, the event is recurrent but not periodic. The end of data entry event indicates that the user is inactive on their terminal. It is for example the end of a keyboard input or the end of moving a pointing device (mouse, trackball, trackpoint, joystick, touch screen, etc.).

In some embodiments of the present application, the at least one update to the knowledge base comprises an addition limited to information not already contained in the knowledge base.

In this way, in some embodiments, writing operations to the knowledge base can be limited.

According to another aspect, a computer program product comprising program code instructions that, when executed by a computing machine (computer, processor, etc.), carry out the above-mentioned method in any of its various embodiments, is proposed.

According to yet another aspect, a non-transitory computer-readable storage medium, storing a computer program comprising a set of instructions executable by a computing machine (computer, processor, etc.) to implement the above-mentioned method in any of its various embodiments, is proposed.

According to yet another aspect, a computing machine configured to carry out the above-mentioned method in any of its various embodiments.

### BRIEF DESCRIPTION OF THE DRAWINGS

Other characteristics and advantages of the development will emerge upon reading the following description, provided as a non-restrictive example and referring to the annexed drawings, wherein:

FIG. 1 shows a simplified flowchart of the method according to the development;

FIG. 2 is an example of a rendering from a screen of a terminal, to illustrate an application example of the method of FIG. 1; and

FIG. 3 shows the structure of a computing machine, according to a particular embodiment, configured to carry out the method of FIG. 1.

### DETAILED DESCRIPTION OF CERTAIN EMBODIMENTS

In all the figures in this document, identical elements and steps are designated by the same reference number.

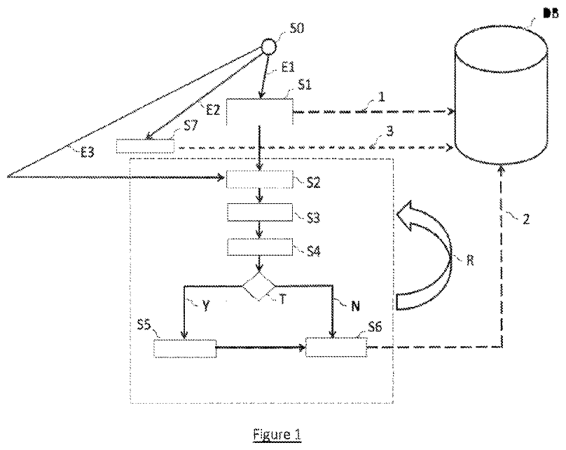

A particular embodiment of the method according to the development for constructing a knowledge base (referred to as DB for “database”) associated with a user of a terminal is now presented in relation to the flowchart of FIG. 1. Once this knowledge base is sufficiently rich in information, an intelligent assistant can use it to offer innovative services such as learning support.

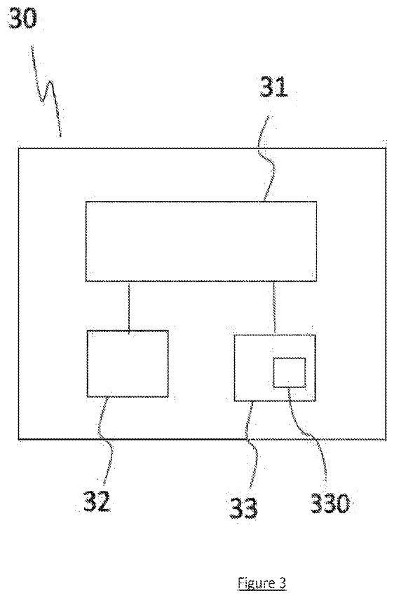

The method is implemented by a computing machine (also referred to as a “system” in the remainder of the description), an example of the structure of which is shown below in relation to FIG. 3. In a first implementation, the computing machine implementing the method is integrated into, or merged with, the user's terminal (this terminal is for example a fixed or portable personal computer, a digital tablet, a personal digital assistant, a smartphone, a workstation, etc.). In a second implementation, the computing machine implementing the method is integrated into, or merged with, another device that cooperates with the user's terminal (this other device is, for example, a home gateway, also known as an “Internet box”).

In this particular embodiment, it is assumed that the user's terminal allows multiwindowing, that is the simultaneous display of several application windows on the screen of the terminal. As already mentioned above, an application window is a window linked to the execution of an application by the terminal. Many applications can be executed by the terminal:
file management applications (for example, “Windows Explorer” or Apple “Finder”);
e-mail applications, also known as “e-mail clients” (for example, Microsoft Outlook or Apple “Mail”);
instant messaging applications (for example, “WhatsApp”);
multimedia conferencing applications;
web browsers (for example, “Microsoft Internet Explorer” or “Google Chrome”);
word processing applications (for example, “Word”);
spreadsheet applications (for example, “Excel”);
presentation applications (for example, “Microsoft PowerPoint” or Apple “Keynote”);
etc.

It is also assumed, in the detailed embodiment, that the operating system of the terminal is capable of retrieving, and providing to the computing machine implementing the present method, certain events related to multiwindowing, such as:
an event E1 indicating the opening of a new application window, and containing information on the position, the size and/or the display rank of the application window;
an event E2 indicating the closing of an application window;
an event E3 indicating the resizing and/or the moving of an application window, and containing information about the new position and/or the new size and/or the new display rank of the application window.

The position and/or size information can be used to find out the coordinates of the application window in the screen, that is to know exactly which pixels of the screen correspond to the area of the application window. For example, the current standard situation where the application window is rectangular in shape and the information about its position and/or its size is formed by an X,Y position (for example of an angle of the rectangular window) and a pair (height, width) is considered. The present development is not limited to rectangular shaped application windows, but applies to any shape (round, oval, etc.).

The display rank, also known as the “scheduling value”, indicates, for example, that the window is displayed in the foreground or in the background, behind one or more other windows.

In the illustrated embodiment, in a step S0, the computing machine seeks to detect events related to multiwindowing such as at least some of the above-mentioned events E1, E2 and/or E3.

If an event E1 is detected (indicating the opening of a new application window), the method can proceed to a step 51 during which the computing machine creates a new entry, also called a new activity, in the knowledge base DB (as illustrated by the arrow referenced 1). An activity can therefore be associated, in the illustrated embodiment, with a particular application window displayed on the screen of the terminal, and group together all the items of information extracted from this application window (for example, as detailed below, all the texts (read or written by the user) appearing in the application window as well as the results of the semantic analysis of the images manipulated within the application window) from its opening to its closing. Furthermore, in step S1, the computing machine can store in the knowledge base DB (for example, in an open window management table, each row of which is specific to a separate application window) information about the position, the size and/or the display rank of the new application window.

In the illustrated embodiment, in a step S2, the computing machine can create a screenshot, for example in the form of a digital image, of part of the rendering from the screen corresponding to the application window, by means of the information (stored in step 51) on the position, the size and/or the display rank of the application window.

In a step S3, the computing machine can identify useful application areas in the digital image resulting from the screenshot created in step S2. Useful application areas are areas that are not related to a presentation of features of the application for which the above-mentioned application window is displayed on the screen of the terminal in the illustrated embodiment.

In a particular implementation of step S3, the computing machine can identify the areas of the application window reserved for menus, buttons and/or other mechanisms for presenting the features of the application. This identification of the areas related to the application's features can be performed, for example:
by coupling known techniques for segmenting the image into rectangular sub-areas with known identification techniques via OCR (Optical Character Recognition), in order to identify common keywords in these rectangular sub-areas (notably: “open”, “file”, “home”, “insert”, “create”, “layout”, “exit”, “save”, “yes”, “cancelled”, etc.);
by detecting aligned round or rectangular icons, using mechanisms such as artificial intelligence (AI), automatic classification, computer vision, etc.

In some embodiments of the present application, once identified, the areas reserved for the presentation of the application's features can be ignored. For example, only the remaining areas of the application window are tagged as “useful application areas” and their position on the overall screen is stored.

In a step S4, the computing machine can extract information from the useful application areas identified in step S3. In some embodiments of the present application, two types of extraction are for example performed: extraction of information on text appearing in the useful application areas, by means of an OCR technique, and extraction of information on image elements appearing in the useful application areas, by means of a computer vision technique (allowing for example text recognition, table recognition, specific element recognition (image representing an animal, a vehicle, etc.)). The information sought to be extracted from the useful application areas can be defined more generally as representative of incoming useful data, provided by the user to the application, and/or outgoing useful data, provided by the application to the user. This can therefore include all the data entered by the user via one or more items of entry equipment of a user interface (for example, a keyboard or a pointing device such as a mouse, trackball, trackpoint, joystick, touch screen, etc.), as well as all the data received by the user (notably responses that the user may get from the application itself or from contacts with whom they communicate via the application, or from images they manipulate or view through the application).

In some embodiments of the present application, a text (for example, line) or image element recognised by a recognition technique (OCR, computer vision, etc.) can be ignored if the confidence score associated with the recognition is below a particular threshold (configuration parameter). In other words, an extracted item of information is considered only, for example, if it is associated with a detection confidence score higher than a first confidence value.

In some embodiments of the present application, if the computing machine detects that a useful application area contains a video, it can decide to ignore it (for example, taking into account at least one configuration parameter). In a variant, it can decide to process this useful application area a posteriori (updating the knowledge base later, in the evening for example, based on information extracted from the video) to avoid using too many system resources during a real-time processing operation of step S4.

In a particular embodiment, the computing machine can identify useful application areas that are completely or partially overlapped by other application windows. This identification can be performed by using directly the open table management table, that contains their position, their size and/or their display rank (see step S1). If a useful application area is detected as being partially or completely overlapped, it can be ignored by the computing machine in step S4 (for example, no information is extracted). For example, in some embodiments, the computing machine can calculate an overlap rate of the useful application area by at least one other application window, based on various information (information on the position and/or the size of the useful application area, information on a display rank of the application window, and information on the position, the size and/or the display rank of the other application window(s)) and the useful application area can, for example, be considered by taking into account the overlap rate. The useful application area can, for example, be taken into account only if the overlap rate is lower than a first overlap value.

Step S4 can be followed by a test step T in which the computing machine detects if the application window being processed is a newly opened window (case, hereinafter referred to as the first case, where the present iteration of steps S2 to S4 is the first iteration since the detection of the event E1), or an application window that was open (case, hereinafter referred to as the second case, where the present iteration of steps S2 to S4 is not the first iteration since the detection of the event E1).

In the first case, the computing machine can perform, in some embodiments, a step S6 in which the information (useful data) extracted in step S4 is added to the user's knowledge base DB (as illustrated by the arrow referenced 2), by being attached to the activity (knowledge base entry) associated with the current application window (whose opening has been detected by the event E1).

In the second case, the computing machine can perform, in some embodiments, a step S5 in which it identifies, among the items of information (useful data) extracted in step S4, the one (hereinafter referred to as “new extracted information”) that is not already contained in the knowledge base DB. Then, the computing machine can perform step S6 but here by adding to the knowledge base DB only the new extracted information (if there is none, step S6 is not performed), and by attaching it to the activity associated with the current application window. Thus, if a text for example has been added (respectively modified) in a useful application area, the method can extract and/or store it, for example by tagging it with the status “ADDED” (respectively “MODIFIED”).

As long as the application window is open and is not resized or moved, the computing machine can repeat steps S2 to S6 (as illustrated by the arrow referenced R) to extract further information, to enrich the knowledge base DB as it goes along and to report on the user's use of the application (that is keep continuous track of user's actions and their interactions with the application and/or their contacts). A new iteration, which results in a new update to the knowledge base, is performed on a triggering event generated by a triggering module, such as a periodic deadline event (every N seconds, for example) or an event indicating an end of data entry via the items of entry equipment (keyboard, pointing device, etc.) of a user interface (event retrievable via the operating system of the terminal). The triggering event indicating an end of data entry is used for example if, when a periodic deadline triggering event is detected (after N seconds, for example), the user is entering data. In this case, the triggering event indicating an end of data entry waits for the end of, or a pause in, the user's input before creating another screenshot.

If an event E2 is detected, indicating the closure of the application window (for example, because the user has closed the application window or exited the application, depending on the terminal used), the method can proceed, in some embodiments, to a step S7 in which the computing machine can close the associated activity, by changing the status of this activity (to “completed”, for example) in the knowledge base DB.

If an event E3 is detected, indicating a resizing and/or a moving of the application window, the method can be resumed for example at step S2 so that useful application areas of this application window can be identified again and new information can be extracted (thanks to the new position and/or the new size and/or the new display rank of the application window). The open window management table (that stores the list of open windows with their position, their size and/or their display rank) can also be updated accordingly.

All the operations and steps described above can be performed for each application, and therefore for each application window. Thus, in the knowledge base DB, a list of extracted and time-stamped items of information can therefore be attached to an activity (associated with an application window).

### Variant of the Method

In a variant, the computing machine may not handle some of the events E1, E2 and/or E3 and not perform some of the steps S0, S1 and S7. It can execute, for example, the iterative mechanism of steps S2 to S6 as described above with FIG. 1, except that in step S2 it can create a screenshot, in the form of a digital image, of the totality of the rendering from the screen (and not just a part corresponding to a particular application window).

In other words, in such an embodiment, only one activity is considered and the method recalculates at regular intervals the useful application areas to extract from them information to enrich the knowledge base DB. With this variant, the knowledge base is less complete than in the embodiment of FIG. 1, but it already allows intelligent assistants to offer contextual help services.

This variant can be applied for example in the case where the terminal can only display one application window at a time (in the case of a smartphone-type terminal for example). This variant can also be applied in the case where the terminal allows multiwindowing but the computing machine is not able to retrieve the events E1, E2 and/or E3 related to multiwindowing (for example because the operating system of the terminal does not allow it, or for other reasons).

### Application Example

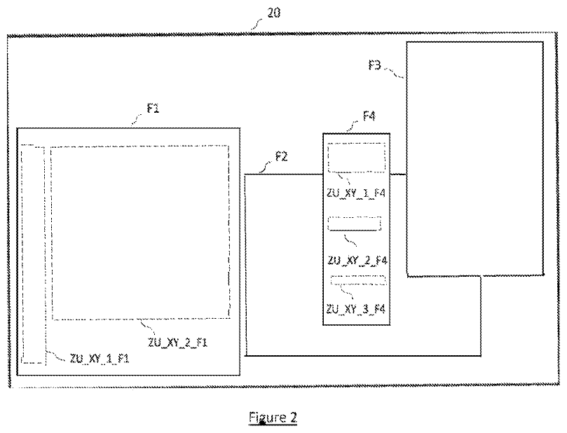

An example of application of the method of FIG. 1 is now presented in relation to FIG. 2 that illustrates an example of rendering from a screen of a terminal.

It is assumed that three application windows F1, F2 and F3 are already open and that the open window management table contains four items of information for each window (that is identifier of the window, position of the window, size of the window and/or display rank of the window):
for window F1: “Multimedia Conferencing—State of the Art”, “position_XY_F1”, “Size_F1”, “Scheduling 1”;
for window F2: “File Explorer—This PC”, “position_XY_F2”, “Size_F2”, “Scheduling 1”; and
for window F3: “IM—Mync”, “position_XY_F3”, “Size_F3”, “Scheduling 2”.

It is also assumed that on their terminal (their PC, for example), the user received a notification from an instant messaging application and clicked on it, causing a new application window F4 (window related to the instant messaging application) to open.

In step S0, the computing machine receives an event E1 indicating the opening of the window F4 and containing the following information: identifier of the window (“IM<PersonName>”), position of the window (“position_XY_F4”), size of the window (“Size_F4”) and display rank of the windows (“Scheduling 2”).

In step S1, the computing machine creates a new activity (“A1: IM <PersonName>”) in the knowledge base and stores in the open window management table the above information relating to the window F4.

In step S2, the computing machine creates a screenshot, in the form of a digital image, of part of the rendering from the screen 20 corresponding to the window F4.

In step S3, the computing machine identifies three useful application areas, ZU_XY_1_F4, ZU_XY_2_F4 and ZU_XY_3_F4 corresponding to the window F4.

In step S4, the computing machine extracts information from the useful application areas identified in step S3, for example text information:
item of information extracted from the area ZU_XY_1_F4: <text1>;
item of information extracted from the area ZU_XY_2_F4: <text2>; and
item of information extracted from the area ZU_XY_3_F4: <text3>.

In step S6, the computing machine updates the activity “A1: IM <PersonName>” in the knowledge base by adding a batch of time-stamped items of information, such as:
identifier of the batch of time-stamped items of information: “Event1 Timestamp”;
item of information extracted from the area ZU_XY_1_F4: <text1>;
item of information extracted from the area ZU_XY_2_F4: <text2>; and
item of information extracted from the area ZU_XY_3_F4: <text3>.

It is assumed that after N seconds, the computing machine detects the first triggering event and that nothing has changed on the screen since the previous screenshot (previous step S2). The computing machine performs for the window F4 a new iteration of steps S2, S3 and S4 (which will provide the same results as in the previous iteration) and then executes step S5. In this step S5, the comparison with the previously stored knowledge base elements (batch of time-stamped items of information with the identifier “Event1_Timestamp”) indicates that no new information has been extracted. The processing operation stops here (step S6 is not performed).

It is assumed that after N other seconds, the computing machine detects a second triggering event, and that the user is typing text (<text4>) on the keyboard in the useful area “ZU_XY_3_F4”. The computing machine then waits for a third triggering event indicating an end of input (corresponding to an actual end of input or a pause in input sufficiently large to represent an end of input). Following the third triggering event, the computing machine performs a new iteration of steps S2, S3 and S4 for the window F4. The new iteration of step S4 does not provide the same results as in the previous iteration, since the computing machine extracts the following information from the useful application area ZU_XY_3_F4: <text3> and <text4> (instead of just <text3>). The computing machine then executes step S5 and the comparison with the previously stored knowledge base elements for the window F4 (batch of time-stamped items of information with the identifier “Event1 Timestamp”) indicates that a new item of information <text4> has been extracted. The processing operation continues with step S6 in which the computing machine updates the activity “A1: IM<PersonName>” in the knowledge base by adding a new batch of time-stamped items of information, such as:
identifier of the batch of time-stamped items of information: “Event2_Timestamp”; and
new item of information extracted from the area ZU_XY_3_F4: ADDED=<text4>.

Let's continue with the example, considering the processing of the window F1, where the user is following a videoconference.

Upon opening of the application window F1 (linked to a videoconferencing application), the computing machine receives in step S0 an event E1 indicating the opening of the window F1 and containing the following information: identifier of the window (“Multimedia Conferencing—State of the Art”), position of the window (“position_XY_F1”), size of the window (“Size_F1”) and display rank of the window (“Scheduling 1”).

In step S1, the computing machine creates a new activity (“A2: Multimedia Conferencing <PersonName>”) in the knowledge base and stores in the open window management table the above information relating to the window F1.

In step S2, the computing machine creates a screenshot, in the form of a digital image, of part of the rendering from the screen 20 corresponding to the window F1.

In step S3, the computing machine identifies two useful application areas, referenced ZU_XY_1_F1 and ZU_XY_2_F1 on FIG. 2.

In step S4, the computing machine extracts information from the useful application areas identified in step S3, for example text information:
item of information extracted from the area ZU_XY_1_F1: <empty> (it is assumed in this example that there is no extracted text because the detection confidence scores via OCR do not validate the extracted text as it is too small);
item of information extracted from the area ZU_XY_2_F1: <text1′>.

In step S6, the computing machine updates the activity “A2: Multimedia Conferencing <PersonName>” in the knowledge base by adding a batch of time-stamped items of information, such as:
identifier of the batch of time-stamped items of information: “Event1_Timestamp”;
item of information extracted from the area ZU_XY_1_F1: <empty>; and
item of information extracted from the area ZU_XY_2° F.1: <text1′>.

It is assumed that after N seconds, the computing machine detects a triggering event and that a new slide has been displayed in the window (more precisely in the area ZU_XY_2_F1) since the previous screenshot (previous step S2). The computing machine performs a new iteration of steps S2, S3 and S4 for the window F1. The new iteration of step S4 does not provide the same results as in the previous iteration, since the computing machine extracts the following information from the useful application area ZU_XY_2° F. 1: <text2′> (instead of <text1′>). The computing machine then executes step S5 and the comparison with the previously stored knowledge base elements for the window F1 (batch of time-stamped items of information with the identifier “Event1_Timestamp”) indicates that a new item of information <text2′> has been extracted. The processing operation continues with step S6 in which the computing machine updates the activity “A2: Multimedia Conferencing <PersonName>” in the knowledge base by adding a new batch of time-stamped items of information, such as:
identifier of the batch of time-stamped items of information:“Event1_Timestamp”;
item of information extracted from the area ZU_XY_2_F1: ADDED=<text2′>.

FIG. 3 shows an example of the structure of a computing machine 30 for carrying out (executing) the method of FIG. 1.

This structure comprises a random access memory 32 (a RAM memory, for example), a read-only memory 33 (a ROM memory or a hard disk, for example) and a processing unit 31 (equipped for example with at least one processor and controlled by at least one computer program 330 stored in the read-only memory 33). At initialisation, the code instructions of the computer program 330 are for example loaded into the random access memory 32 before being executed by the processor of the processing unit 31.

This FIG. 3 only shows a particular one of several possible ways of implementing a computing machine to carry out (execute) the method. Indeed, the computing machine may be implemented indifferently in the form of a reprogrammable computing machine (a PC computer, a DSP processor or a microcontroller) executing a program comprising a sequence of instructions, or in the form of a dedicated computing machine (for example a set of logic gates such as an FPGA or an ASIC, or any other hardware module).

In the case of an implementation in the form of a reprogrammable computing machine, the corresponding program (that is the sequence of instructions) can be stored in a removable (such as, for example, a floppy disk, CD-ROM or DVD-ROM) or non-removable storage medium, this storage medium being partially or totally readable by a computer or a processor. Alternatively, the storage medium can be an integrated circuit in which the program is embedded, the circuit being adapted to execute or to be used in the execution of the above-mentioned method according to the development.

As a variant, the storage medium can be a transmissible medium such as an electrical or optical signal, that can be carried via an electrical or optical cable, by radio link, by optical link or by other means. The program according to the development can be downloaded in particular on an Internet-type network.

1. A method, implemented by a computing machine, for constructing a knowledge base-(DB) of a user, wherein the method comprises at least one update to use information contained in the knowledge base of the user and relating to a use of at least one terminal of the user, based on information extracted from useful application areas of a digital image of a screenshot of at least part of the rendering from at least one screen of a terminal, the useful application areas being areas containing at least one item of data provided by at least one application via the at least one screen or received by the application via a user interface of the terminal and rendered on the screen.

2. A computing machine comprising at least one processor configured to perform at least one update to use information contained in a knowledge base of a user and relating to a use of at least one terminal of the user, based on information extracted from useful application areas of a digital image of a screenshot of at least part of the rendering from at least one screen of a terminal, the useful application areas being areas containing at least one item of data provided by at least one application via the at least one screen or received by the application via a user interface of the terminal and rendered on the screen.

3. The method according to claim 1, wherein the screenshot applies to the entire rendering from the screen.

4. The method according to claim 1, wherein the screenshot applies to at least part of the rendering from the screen corresponding to an application window displayed on the at least one screen.

5. The method according to claim 4, wherein the method comprises, upon detection of an opening of the application window on the screen, storing in the knowledge base information on the position, the size and/or a display rank of the application window, and in that, for a new update to the knowledge base, the screenshot depends on the information on the position, the size and/or the display rank.

6. The method according to claim 4, wherein, if the terminal allows several application windows to be displayed on the screen simultaneously, at least one update to the knowledge base is performed in a separate entry of the knowledge base for each of the application windows.

7. The method according to claim 6, wherein, for a useful application area of an application window, at least one update to the knowledge base is performed conditionally taking into account an overlap rate of the useful application area by one or more other application windows.

8. The method according to claim 7, wherein the overlap rate of the useful application area by one or more other application windows depends on:
information on the position and/or the size of the useful application area;
information on a display rank of the application window; and/or
information on the position, the size and/or a display rank of the other application window(s).

9. The method according to claim 7, wherein at least one update to the knowledge base, for the useful application area of the application window, is performed only when the overlap rate is lower than a first overlap value.

10. The method according to claim 4, wherein, upon detection of a resizing and/or a moving of an application window, the method comprises storing in the knowledge base new information on the position, the size and/or the display rank of the application window, and in that, for each new update to the knowledge base, the screenshot depends on the new information on the position, the size and/or the display rank.

11. The method according to claim 1, wherein the useful application areas are areas that are not related to a presentation of features of the at least one application and for which an application window is displayed on the screen.

12. The method according to claim 1, wherein the extraction of information from the useful application areas comprises an extraction belonging to a group comprising:
extracting information on text appearing in the useful application areas by an optical character recognition technique; and
extracting information on image elements appearing in the useful application areas by a computer vision technique.

13. The method according to claim 1, wherein the extraction of information from the useful application areas takes into account a detection confidence score.

14. (canceled)

15. A processing circuit comprising a processor and a memory, the memory storing program code instructions of a computer program that, when the computer program is executed by the processor, implements the method according to claim 1.

16. (canceled)

17. The computing machine according to claim 2, wherein the screenshot applies to the entire rendering from the screen.

18. The computing machine according to claim 2, wherein the screenshot applies to at least part of the rendering from the screen corresponding to an application window displayed on the at least one screen.

19. The computing machine according to claim 18, wherein the processor is configured to perform, upon detection of an opening of the application window on the screen, storing in the knowledge base information on the position, the size and/or a display rank of the application window, and in that, for a new update to the knowledge base, the screenshot depends on the information on the position, the size and/or the display rank.

20. The computing machine according to claim 18, wherein, if the terminal allows several application windows to be displayed on the screen simultaneously, at least one update to the knowledge base is performed in a separate entry of the knowledge base for each of the application windows.

21. The computing machine according to claim 20, wherein, for a useful application area of an application window, at least one update to the knowledge base is performed conditionally taking into account an overlap rate of the useful application area by one or more other application windows.

22. The computing machine according to claim 21, wherein the overlap rate of the useful application area by one or more other application windows depends on:
information on the position and/or the size of the useful application area;
information on a display rank of the application window; and/or
information on the position, the size and/or a display rank of the other application window(s).

23. The computing machine according to claim 21, wherein at least one update to the knowledge base, for the useful application area of the application window, is performed only when the overlap rate is lower than a first overlap value.

24. The computing machine according to claim 18, wherein, upon detection of a resizing and/or a moving of an application window, the processor is configured to perform storing in the knowledge base new information on the position, the size and/or the display rank of the application window, and in that, for each new update to the knowledge base, the screenshot depends on the new information on the position, the size and/or the display rank.

25. The computing machine according to claim 2, wherein the useful application areas are areas that are not related to a presentation of features of the at least one application and for which an application window is displayed on the screen.

26. The computing machine according to claim 2, wherein the extraction of information from the useful application areas comprises an extraction belonging to a group comprising:
extracting information on text appearing in the useful application areas by an optical character recognition technique; and
extracting information on image elements appearing in the useful application areas by a computer vision technique.

27. The computing machine according to claim 2, wherein the extraction of information from the useful application areas takes into account a detection confidence score.
